(19) United States
(12) Patent Application Publication
(10) Pub. No.: US 2011/0153582 A1
(43) Pub. Date: Jun. 23, 2011

(54) HANDLING OF CLASSIFICATION DATA BY A SEARCH ENGINE

(76) Inventors: Daniel Buchmann, Eggenstein (DE); Holger Schwedes, Kraichtal (DE)

(21) Appl. No.: 12/644,048

(22) Filed: Dec. 22, 2009

(51) Int. Cl. G06F 17/30

(52) U.S. Cl. 707/706; 707/769; 707/E17.014; 707/E17.108

(57) ABSTRACT

Methods and systems are described herein that involve handling of classification data in a search engine, where classification applies to data models, where attributes differ among the instances of an object type, or where the definitions of an object type's attributes are subject to frequent change. The search engine enables free-style queries and complex queries using Boolean operators. Further, the search engine incorporates algorithms to handle properties of an object type instance provided in the search query as if they were attributes of the object type's index.

### TECHNICAL FIELD

Embodiments of the invention generally relate to the software arts, and, more specifically, to methods and systems for handling classification data by a search engine.

### BACKGROUND

In the computer world, a search engine is an information retrieval system designed to find information stored on a computer system. Search engines provide an interface to a group of items that enables users to specify criteria about an item of interest and have the engine find the matching items. The criteria are referred to as a search query. The list of items that meet the criteria specified in the query is typically sorted, or ranked. To provide a set of matching items that are sorted according to some criteria quickly, a search engine will typically collect metadata about the group of items under consideration beforehand through a process referred to as indexing. The purpose of storing an index is to optimize speed and performance in finding relevant information for the search query.

Besides unstructured content such as text, objects to be indexed in a search engine usually have, at least a few attributes: from the mime type of a file to a complex structured business object. Objects can be summarized in types such as “Business Partner” or “File”. Instances of an object type typically share a structure definition. Yet there may be attributes whose definitions are frequently changed; or attributes that are not common to all instances of a type. In these and related use cases data classification may be used. Data classification consists of a property dictionary, where the properties may have a list of valid codes, and a property valuation, where one or more specific properties are assigned to the object in question, and where these properties are evaluated. There may also be a grouping of properties in classes. A class is a group of objects described by means of characteristics that they have in common. The characteristics represent properties that describe and distinguish between objects. Each property has its own name, type, language dependent description (e.g., “color” (EN), “Farbe” (DE), “couleur” (FR), etc.), default unit, and so on.

The definition and usage of the properties maybe according to the several standards ISO13584-42, IEC61360-1-2, and DIN4002. ISO13584-42 specifies a methodology for structuring part families IEC61360-1-2 provides a firm basis for the clear and unambiguous definition of characteristic properties of all elements of systems from basic components to sub-assemblies and full systems. DIN4002 specifies a practicable solution towards building up a dictionary of properties with accompanying reference hierarchy structure. Many business object types consist mostly of classification; a static structure is typically only available for the very basic data. Classification system allows users to assign objects to different classes and the objects to inherit the properties of the assigned classes. Classification is a vital concept for a widespread set of usages, and being able to search in classification data is advantageous.

### SUMMARY

Methods and systems are described here that involve handling of classification data by a search engine. In an embodiment, the method includes identifying a search query that includes a name and value of a property of an object instance. In various embodiments the property name and the property value are indexed with predefined codes in a classification index. An encoded property key identifier of the property name is determined in a property index. An encoded property value identifier of the property value is determined in a property value index. Finally, a product identifier of the object instance is identified in the classification index in response to determining the encoded property key identifier of the property name and determining the encoded property value identifier of the property value.

In various embodiments, the system includes a classification system storing a plurality of object instances with their properties as characteristics. Further, the system includes a classification index storage unit based on the classification system that indexes the plurality of object instances with their properties. In addition, a search engine is included in communication with the classification index storage unit that performs searches on the classification index. The search engine treats a property of an object instance as if the property is an attribute of the classification index.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram of an exemplary classification index structure for storing data.

FIG. 2 is a block diagram of an exemplary classification index structure for storing data, according to an embodiment.

FIG. 3 is a block diagram comprising a detailed illustration of an exemplary classification index structure for storing data, according to an embodiment.

FIG. 4 is a flow diagram of an embodiment of a method for searching data in an index based on a classification system.

FIG. 5 is a block diagram of an exemplary computer system 500.

### DETAILED DESCRIPTION

Embodiments of techniques for handling of classification data by a search engine are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiment.

A search engine stores the data to be searched in indexes. The indexes have to be defined structurally before they can be filled with data. Changing an index structure after filling the index with data affects the data already contained in the index. The impact can be performance-related when deleting or adding a column. Additional data may need to be added while the old data may need to be kept in the index structure. This might enforce a complete reindexing of all data. These administration tasks are seldom carried out during configuration time.

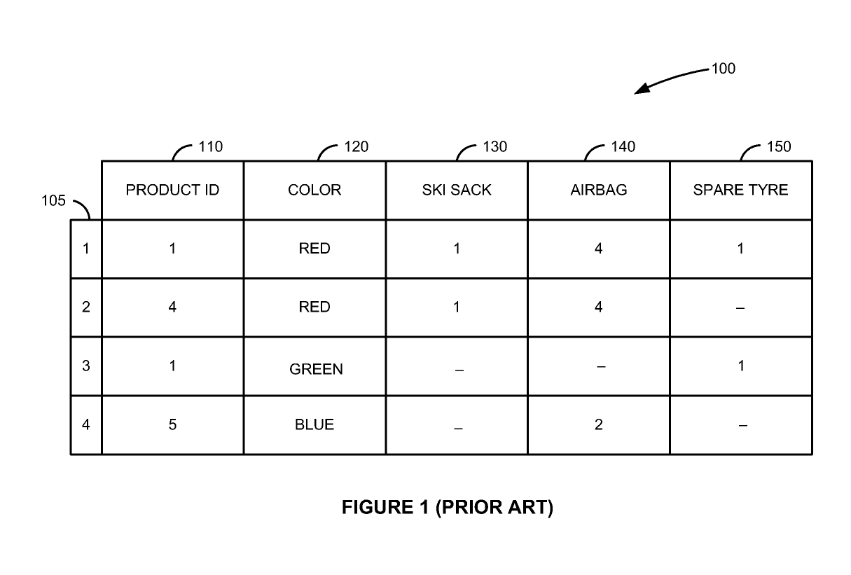

FIG. 1 is a prior art diagram of an exemplary classification index structure for storing data. Since search engines cannot cope with regular classification data, thus, the classification data is transformed to an index to be searchable. The properties of an object of a class become regular attributes of the index with assigned property values as attribute values. Classification index structure 100 represents a simple example that shows how an object of type “car” is stored with its properties. The properties may represent different classes as part of a data classification system. The instances 105 of the object type are coded with product identifiers 110. Each of the object type instances 105 is described with a number of properties such as color 120, ski sack 130, airbag 140, and spare tyre 150. The classification properties may not be common to all instances 105 of a given object type. For example, object type instances 3 and 4 do not have ski sack 130.

There may be tens of thousands of property columns in an index, and only small portion of the data sets have populated columns. As result, managing properties as columns in an index can be inefficient. Further, if a property of an object type instance has to be changed in the index 100, then the entire row has to be updated and indexed again. Applying the regular index principle to classification data, the administrative tasks become relevant on a daily basis, or even more frequent, because of the volatile character of classification property definitions—leading to administrative overhead, indexing overhead, and possibly temporarily missing or inconsistent data.

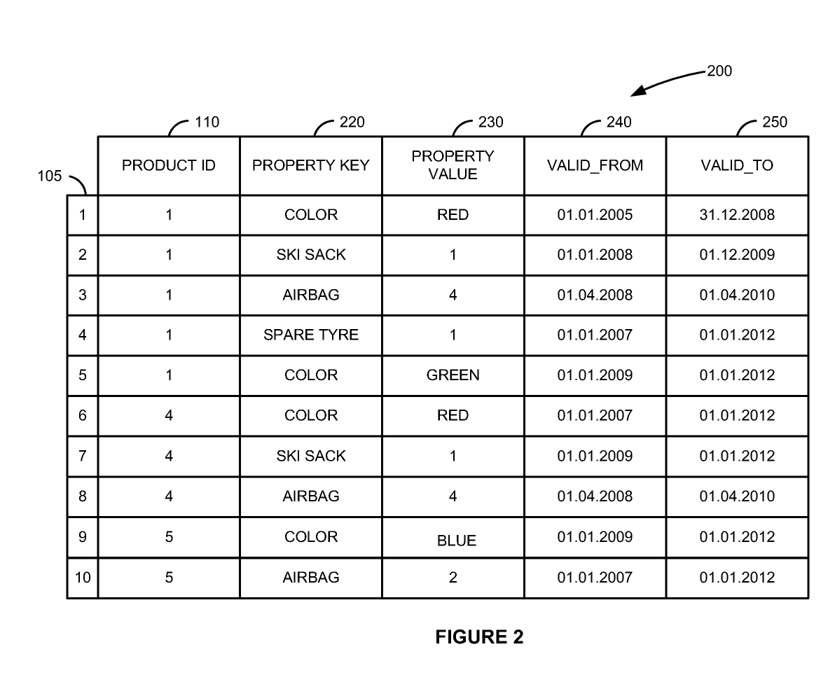

FIG. 2 is a diagram of an exemplary classification index structure for storing data, according to an embodiment. Classification index structure 200 is a simple example of an embodiment that represents another definition of classification index 100 of FIG. 1. The classification index 200 also shows how an object of type “car” is stored with its properties. However, the properties are not listed as attributes of the index in separate columns, instead the columns group the properties under property key 220 (e.g., referred to as the name of the property) and property value 230. Instances of object types are assigned with an identifier from product ID 110. Further, object type instances are stored with the corresponding available properties, such that all entities of the index are populated. For example, in FIG. 1, object type instance 4 that is assigned with product ID 5 has only two properties, describing the object instance as a blue car with two airbags, the units of its index row for “ski sack” and “spare tyre” are empty. However, in FIG. 2, index 200, the same object type instance with product ID 5 is listed with just the two properties: color and airbag, without keeping additional index space for non-existing properties (e.g., ski sack). When there is more than one property value for object type instances with same product IDs, they are listed as separate rows with the corresponding property and the other property value. For example, object type instance 5 in column 105 has the product ID 1 and the same property key color as object type instance 1 in column 105, but different property value (e.g., “green” for object type instance 5 and “red” for object type instance 1).

Adding or deleting a property is an easy operation that does not require much administrative or indexing overhead. Since each property is stored separately in a row for a given object type instance and is not valid for all object type instances, removing a row or adding a row will affect only the given object type instance. Similarly, a property can be changed by deleting an old property data and adding a new row with new data to the index; in this way only the corresponding object type instance is affected.

In an embodiment, each property value 230 in the classification index 200 has its own validity range information. A “valid_from” 240 attribute and a “valid_to” 250 attribute define a validity period for the property valuation. When a validity period expires, a new row to the index can be added for the same property of the object type instance and product ID with a new validity period. The object instance property with the old validity period is kept in the index to provide data for that given period.

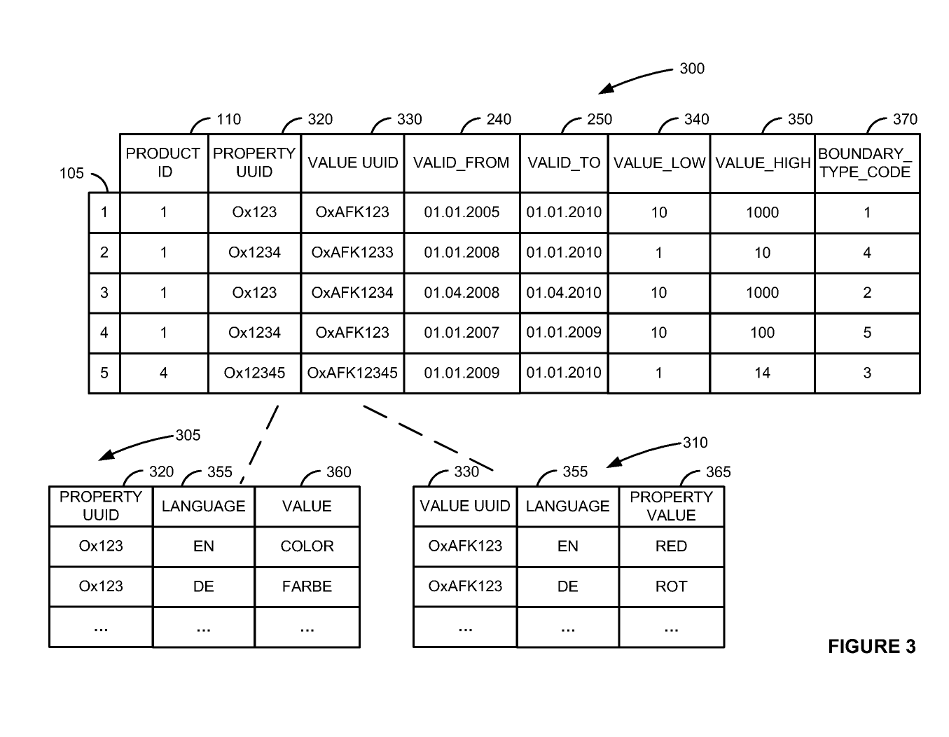

FIG. 3 is a detailed diagram of an exemplary classification index structure for storing data, according to an embodiment. Index structure 300 is a detailed example of an embodiment for storing classification data. Generating or maintaining a large-scale search engine index represents a significant storage and processing challenge. Typically, the search engines utilize a form of compression to reduce the size of the indices on the disk. Depending on the compression technique chosen, the index can be greatly reduced. Due to the compression, some of the data becomes encoded and the index entities refer to other index structures. Index structure 300 is an encoded index based on classification data that contains a set of attributes for structuring the data. The instances 105 of the object type are identified with product identifiers 110.

Column 320 contains universally unique identifiers (UUIDs) of the encoded property keys 220. The property keys (names) are stored in a separate index structure 305 that contains the property keys and the corresponding property UUIDs. Property index structure 305 includes the property UUIDs 320, language 355, and value 360 attributes. Language 355 specifies the language of the property. The property key is language-dependent. Value 360 specifies the property name (key) in the specified language that corresponds to the given property UUID. For example, “Ox123” is a property UUID for property key “color” specified in English and also is a property UUID for property key “Farbe” specified in German. Thus, if a user searches an object by properties in different languages, the same object will be returned by the search engine.

Column 330 contains UUIDs of the encoded property values 230. Similarly, the property values are stored in a separate index structure 310 that contains the property values with the value UUIDs that correspond to the encoded property key UUIDs of index 305. Value index structure 310 includes the value UUIDs 330, language 355, and property value 365 attributes. Language 355 specifies the language of the property value. The property value is language-dependent. Property value 365 specifies the property value in the specified language that corresponds to the given value UUID. For example, “OxAFK123” is a value UUID for property value “red” specified in English and also is a value UUID for property value “rot” specified in German. Both values correspond to property key UUID “Ox123” 320. The property key index 305 and the property value index 310 are linked to the classification index 300 and may also be linked to each other, so that the stored data can be retrieved upon a request to index 300 via a search engine.

Index structure 300 also contains validity period information for each property value. A “valid_from” 240 attribute and a “valid_to” 250 attribute define the validity period (e.g., validity dates) for the property valuation. Further, for each numerical property value, a valuation range is specified. The valuation range consists of value_low 340 specifying a lower valuation limit, value_high 350 specifying a maximum high valuation limit, and a boundary_type_code 370. The boundary_type_code 370 specifies the boundary types of an interval. For example, an interval from 3 to 7 may include the following boundary types: [3;7]—including 3 and 7; (3;7] —including 7, but excluding 3; or 3 can be exactly 3, less than 3 (“<3”), or less and equal to 3 (“=<3”). In an embodiment, the boundary types may be mapped to numerical representations. For example, “=” to 1; “[ )” to 2; “[ ]” to 3, e.g., [X;Y]; “( )” to 4; “( ]” to 5; “<” to 6; “<=” to 7; “>” to 8; and “>=” to 9. Some non-numeric property values may also have a valuation range, if they have code lists with a scale, where an interval can be defined. For example, colors may be defined in a separate predefined table with codes: FFFFF0—ivory, FFFF00—yellow; then, a validity range can be defined with these codes: FFFFF0-FFFF00, the range will include those colors mapped to the codes range according to the predefined table.

In an embodiment, all attributes of the classification index 300 (e.g., validity range, valuation range, property UUID, and so on) are stored in an index separate from the main classification index 300. During generation of index 300, the needed attributes are selected from the list.

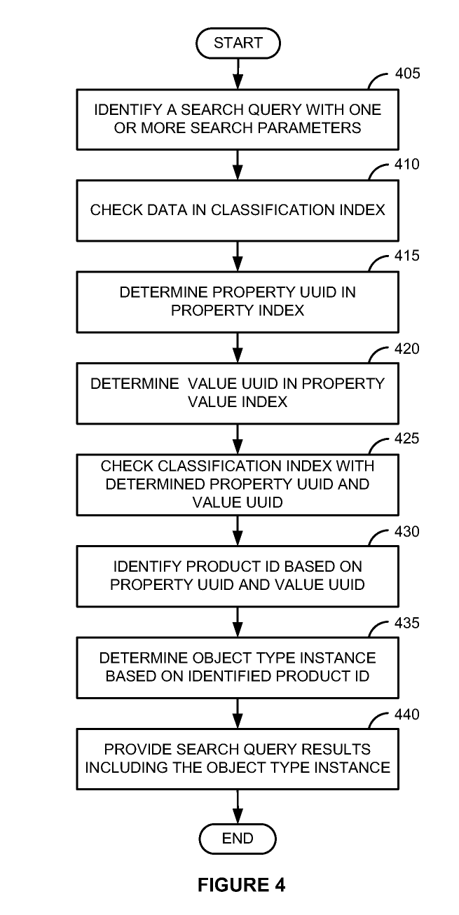

FIG. 4 is a flow diagram of an embodiment for searching data in an index based on a classification system. In various embodiments, a search engine knows the semantics and metadata of the classification index 300. The properties attached to an object instance are not handled as additional columns, but there are other indexes (e.g., 305 and 310) where the attached properties and their respective valuations for each object instance are stored as name-value pairs. The search engine incorporates algorithms to handle the properties in the search interface as if they were attributes of the object type's index. The search engine also incorporates algorithms that allow users to search the property descriptions and the property data value descriptions of an object instance. Further, the search engine knows about the links between these indexes 300, 305, and 310 (e.g., which attribute of the property index 305 holds the property identifier, and which attribute in the property valuation index 310 refers to it), so that data retrieval is possible. Since index 300 is based on classification data, the search engine is able to search the listed object type instance using the classes, characteristics, and values assigned to the object instances via the classification system.

At block 405, a search query is identified as received at a search engine. The search query includes one or more search parameters, where the parameters represent at least a property name or a property value, describing an object. The object with its properties and property values is described in a classification system. The classification system is linked to the search engine. The search engine uses an index based on the classification system to search in the classification data of the objects. A user may search for the object using one or more of its properties and property values as if they were regular index attributes. In an embodiment, a user can search the classification data via a simple search.

The simple search is a free-style search query that includes one or more property names and one or more property values. The search enables querying the properties in as if they were regular index attributes. For example, if a user enters “color=red” as a search query, the search engine will return all objects that have the color “red” as a characteristic (in the example, where the object instances are of object type “car”, that will be all red cars). The user can enter the search query in a graphical user interface of an application, in a command-line tool, etc. To narrow the search results, the user may enter more criteria using Boolean operators. For example, “color=red AND airbag=4” will search for and return all red cars that have four airbags. Upon entering the search criteria, the application providing the search generates a search query that sends to the search engine for processing. In the example above, the search query is (key=color AND value=red) AND (key=airbag AND value=4).

In another embodiment, the user can search the classification data via an advanced search. The advanced search provides a set of search criteria for specifying a plurality of characteristics of an object. In case of entering the search criteria via a GUI, the properties and values of the needed objects can be entered in GUI components or selected from predefined sets in the UI. Upon entering the search criteria (or selecting them in the UI), the application providing the search generates a search query that sends to the search engine. For example, if a user selects that he or she wants to search for a street with a given street number providing two search options, this will generate the following search query: (street=“Washington Street” AND number=3) OR (street=“Lincoln Street” AND number=7). The search query generated as this differentiates the two streets with the corresponding street numbers and ensures that the search engine will not mix the street numbers of the streets. Alternatively, the user can enter the search query itself in case of using a command-line tool. In either case, simple search or advanced search, the search query is received at the search engine for processing.

At block 410, the search engine checks the data contained in an index (such as index 300). The index is based on classification data. In an embodiment, the indexed data is encoded with predefined codes and the index refers to a number of other indexes that contain the values of the coded data (e.g., property index 305 that stores the properties of an object and property value index 310 that stores the property values). In the identified search query, “key” corresponds to property key (property name) and “value” corresponds to property value. At block 415, the search engine checks the property index 305 to determine the property UUID 320 that refers to property key “color” (e.g., Ox123). At block 420, the search engine checks the property value index 310 to determine the property value UUID 330 that refers to property value “red”. These checks are performed for all entities in the search query to determine UUIDs of the property keys and values.

At block 425, the classification index 300 is checked with the determined property UUIDs and property value UUIDs. At block 430, the product ID(s) that corresponds to the determined property UUIDs and property value UUIDs is identified. The product ID represents a given object type instance. For example, if the object type is “car”, an instance of this object type could be type of car: van, sedan, coupe, etc. At block 435, the object instance type is determined based on the identified product ID. At block 440, a list of search query results is provided to the user. The search results include the determined object type instance(s).

In an embodiment, the user may specify range values of the properties as search criteria including, but not limited to, validity period and range valuation of the indexed data. For example, the user can specify: “color=red AND valid_from=01.01.2008”, which will return those object type instances that meet the search criteria. Another example, the user can specify: “color=red AND airbag>1”, which will return all red cars that have more than one airbag.

Handling of classification data by the search engine provides maintaining and querying validity valuations and range valuations of the properties. Further, the classification index is easily extendable with new properties and values just by adding a new row to the index for a given object type instance. The search engine and the classification index provide a free-style simple search and an advanced search for complex queries via Boolean operators.

Administrative effort is greatly reduced if the classification index (schema) changes, because the changes become effective by regular data indexing. This also means that indexing can add data for new properties according to the usual, scheduled index update frequency—data is consistent during a longer period until the index reorganization takes place. Also, no performance loss on classification schema changes, because the changes become effective by data indexing. The search engine can deal efficiently with classification data since the number of columns of the index stays small, and there are no unpopulated columns for properties not used with a given object instance.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable medium as instructions. The term “computer readable medium” should be taken to include a single medium or multiple media storing one or more sets of instructions. The term “computer readable medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer-readable media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

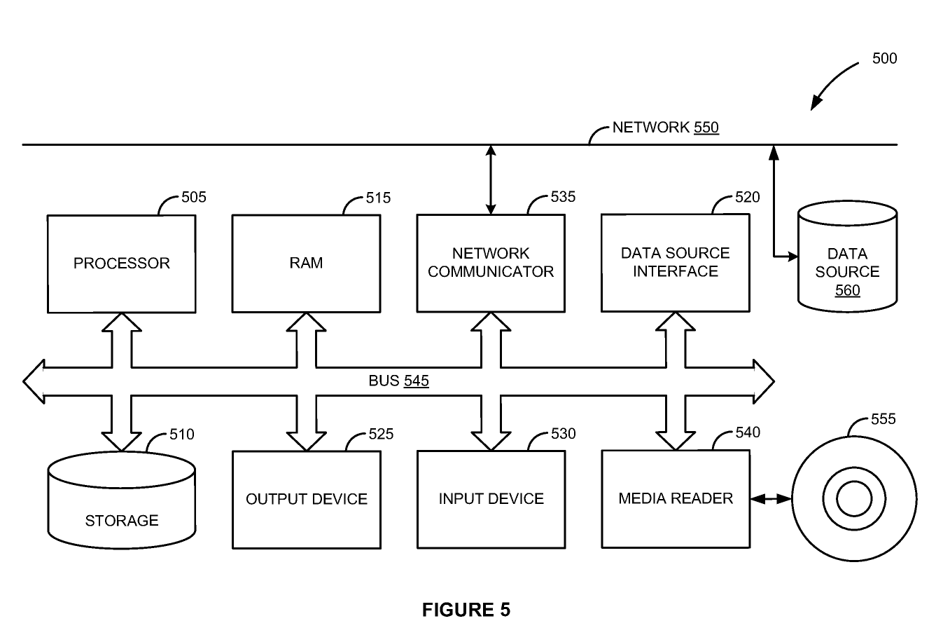

FIG. 5 is a block diagram of an exemplary computer system 500. The computer system 500 includes a processor 505 that executes software instructions or code stored on a computer readable medium 555 to perform the above-illustrated methods of the invention. The computer system 500 includes a media reader 540 to read the instructions from the computer readable medium 555 and store the instructions in storage 510 or in random access memory (RAM) 515. The storage 510 provides a large space for keeping static data where at least some instructions could be stored for later execution. The stored instructions may be further compiled to generate other representations of the instructions and dynamically stored in the RAM 515. The processor 505 reads instructions from the RAM 515 and performs actions as instructed. According to one embodiment of the invention, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be access via one or more abstraction layers implemented in hardware or software. For example, the data source 560 may be access by network 550. In some embodiments the data source 560 may be accessed via an abstraction layer, such as, a semantic layer.

A data source 560 is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer-readable storage medium tangibly storing computer-readable instructions thereon, which when executed by the computer, cause the computer to perform operations comprising:
identifying a search query that includes a property name and a property value of a property of an object instance, wherein the property name and the property value are indexed with predefined codes in a classification index;
determining an encoded property key identifier of the property name in a property index;
determining an encoded property value identifier of the property value in a property value index; and
identifying a product identifier of the object instance in the classification index in response to determining the encoded property key identifier of the property name and determining the encoded property value identifier of the property value.

2. The computer-readable storage medium of claim 1, wherein the operations further comprise:
determining the object instance in response to identifying the product identifier of the object instance.

3. The computer-readable storage medium of claim 2, wherein the operations further comprise:
providing search query results, wherein the results include the determined object instance.

4. The computer-readable storage medium of claim 1, wherein the search query represents a free-style search or an advanced search.

5. The computer-readable storage medium of claim 4, wherein the search query includes a Boolean operator after the property and before a second property represented with a second property name and a second property value in a name-value pair.

6. The computer-readable storage medium of claim 1, wherein the property value is selected from a group consisting of a static value, a validity period, and a range value.

7. The computer-readable storage medium of claim 1, wherein the property index and the property value index are linked to the classification index.

8. The computer-readable storage medium of claim 1, wherein the property of the search query is treated as if the property is an attribute of the classification index.

9. A computer implemented method comprising:
identifying a search query at a search engine that includes a property name and a property value of a property of an object instance, wherein the property name and the property value are indexed with predefined codes in a classification index;
determining an encoded property key identifier of the property name in a property index;
determining an encoded property value identifier of the property value in a property value index; and
identifying a product identifier of the object instance in the classification index in response to determining the encoded property key identifier of the property name and determining the encoded property value identifier of the property value.

10. The method of claim 9, further comprising:
determining the object instance in response to identifying the product identifier of the object instance.

11. The method of claim 10, further comprising:
providing search query results, wherein the results include the determined object instance.

12. The method of claim 9, wherein the search query represents a free-style search or an advanced search.

13. The method of claim 9, wherein the search query includes a Boolean operator after the property and before a second property represented with a second property name and a second property value in a name-value pair.

14. The method of claim 9, wherein the property value is selected from a group consisting of a static value, a validity period, and a range value.

15. The method of claim 9, wherein the property index and the property value index are linked to the classification index.

16. The method of claim 9, wherein the property of the search query is treated as if the property is an attribute of the classification index.

17. A computing system comprising:
a classification system storing a plurality of object instances with their properties as characteristics;
a classification index storage unit based on the classification system that indexes the plurality of object instances with their properties; and
a search engine in communication with the classification index storage unit that performs searches on the classification index, wherein the search engine treats a property of an object instance as if the property is an attribute of the classification index.

18. The computing system of claim 17, further comprising:
a property index storage unit that stores a set of property names with predefined encoded property key identifiers and language-dependent values; and
a property value index storage unit that stores a set of property values with predefined encoded property value identifiers and language-dependent values.

19. The computing system of claim 18, wherein the property index storage unit and the property value index storage unit are linked to the classification index storage unit.

20. The computing system of claim 17, wherein the search engine receives a search query that includes a property name and a property value of the property of the object instance, wherein the property value is selected from a group consisting of a static value, a validity period, and a range value.
